(19) United States
(12) Patent Application Publication
(10) Pub. No.: US 2026/0341950 A1
(43) Pub. Date: Oct. 29, 2026

(54) TRANSPARENT THIN-FILM ANTENNA AND MANUFACTURING METHOD THEREOF

(71) Applicant: SHENZHEN DEMAN ELECTRONICS CO., LTD., Shenzhen City (CN)

(72) Inventors: RUMIN XIAO, Shenzhen City (CN); HAIJUN DAI, Shenzhen City (CN); XU ZHANG, Shenzhen City (CN); BIN ZHANG, Shenzhen City (CN)

(73) Assignee: SHENZHEN DEMAN ELECTRONICS CO., LTD., Shenzhen City (CN)

(21) Appl. No.: 19/707,370

(22) Filed: Jun. 14, 2026

Related U.S. Application Data
(63) Continuation of application No. PCT/CN2025/078445, filed on Feb. 21, 2025.

(30) Foreign Application Priority Data
May 15, 2024 (CN) 202410602976.X

(51) Int. Cl. H01Q 1/12; H01Q 9/04

(52) U.S. Cl. CPC H01Q 1/1271; H01Q 9/0407

(57) ABSTRACT

Disclosed is a transparent thin-film antenna and its manufacturing method, including: providing a base substrate and a conductive substrate layered on the substrate; performing laser depth-controlled cutting treatment on the conductive substrate to form an antenna pattern layer with multiple grooves, wherein the grooves limits the routing distance of the antenna pattern layer, and the portion between two adjacent grooves forms the routing of the antenna pattern layer; laminating the antenna pattern layer with a transparent substrate to fill each groove with the transparent substrate; peeling off the base substrate to make the antenna pattern layer and the transparent substrate to form a transparent thin-film antenna. It does not require additional molds and can eliminate reliance on high-precision imprint molds, reduce costs, and shorten lead time. In addition, copper foil can be used in conjunction with laser depth-controlled cutting process to manufacture antenna pattern layers.

### CROSS-REFERENCE

This application is a continuation of International Application No. PCT/CN2025/078445 with a filling date of Feb. 21, 2025, designating the United States, now pending, which further claims to the benefit of priority from Chinese Application No. 202410602976.X with a filing date of May 15, 2024. The content of the aforementioned applications, including any intervening amendments thereto, are incorporated herein by reference.

### TECHNICAL FIELD

The present disclosure relates to the technical field of antenna manufacturing, in particular to a transparent thin-film antenna and a manufacturing method thereof.

### BACKGROUND

Antennas, as components capable of transmitting and receiving electromagnetic waves, play an important role in wireless communication systems. In recent years, with the continuous development of wireless communication technology, the requirements for wireless communication technology have also been constantly increasing. Therefore, antennas have attracted more and more attention, and research on antennas is also advancing continuously. In some special electronic devices, traditional antennas not only affect the visual appearance, but also are not conducive to safety and concealment in practical environments. Due to the optical transparency and conductivity of transparent conductive films, they can be used to design transparent thin-film antennas, achieving visual beauty, safety and reliability, as well as good concealment. However, there is still a manufacturing process involved in the design and actual use of transparent antennas. The core of preparing transparent thin-film antennas lies in the manufacturing of the antenna pattern layer. Currently, there are three main manufacturing processes on the market: nanoimprint lithography, microcontact printing, and UV nanoimprint lithography.

These processes require the use of high-precision imprint molds, which require multiple mold repairs or reprocessing, resulting in high costs and long lead times. Generally, conductive materials are composed of nano silver and polymer resin, and the high material cost of nano-silver further inflates the overall antenna cost. In addition, due to the polymer resin, the antenna pattern layer exhibits high sheet resistance and poor conductivity. This issue becomes increasingly pronounced as the pattern layer becomes thinner.

### SUMMARY

In view of the above, the present disclosure provides a transparent thin-film antenna and its manufacturing method, which can improve the reliance on high-precision imprint molds for the manufacturing of transparent thin-film antennas, thereby addressing issues such as high costs and long lead time.

The present disclosure provides a method for manufacturing a transparent thin-film antenna, including:
Providing a base substrate and a conductive substrate layered on the base substrate;
Performing laser depth-controlled cutting treatment on the conductive substrate to process the conductive substrate into an antenna pattern layer with a plurality of grooves, wherein the grooves limit a routing distance of the antenna pattern layer, and a portion between two adjacent grooves forms a routing of the antenna pattern layer;
Laminating a transparent substrate onto the antenna pattern layer to fill each groove with the transparent substrate;
Peeling off the base substrate, and the antenna pattern layer and the transparent substrate form a transparent thin-film antenna.

Optionally, wherein the depth of the groove is less than the thickness of the conductive substrate, and the groove bottom of the groove does not expose the base substrate.

Optionally, after laminating the transparent substrate onto the antenna pattern layer, the method further includes:
Etching the antenna pattern layer to remove the groove bottom of the groove.

Optionally, the conductive substrate is copper foil.

Optionally, the thickness of the conductive substrate is D1, and 0<D1≤6 μm, and the thickness of the groove bottom of the groove is greater than or equal to 0.1 μm.

Optionally, the method further includes:
Attaching one side of a transparent double-sided adhesive tape to the antenna pattern layer to allow the transparent thin-film antenna to be attached to a target device through another side of the transparent double-sided adhesive tape.

Optionally, before peeling off the base substrate, the method further includes:
Setting a carrier copper layer on the transparent substrate;
After attaching one side of the transparent double-sided adhesive tape to the antenna pattern layer, the method further includes:
Peeling off the carrier copper layer.

Optionally, the transmittance of the transparent substrate is greater than or equal to 85%.

Optionally, the transparent substrate is a PET film.

The transparent thin-film antenna provided in the present disclosure is made using any of the methods mentioned above.

As mentioned above, the present disclosure uses laser depth-controlled cutting process to manufacture antenna pattern layers. laser depth-controlled cutting has high accuracy and low cost, so there is no need to require additional molds, thereby eliminating reliance on high-precision imprint molds, reducing costs, and shortening lead time. In addition, the present disclosure can use copper foil in conjunction with laser depth-controlled cutting process to manufacture antenna pattern layers, with low material cost, low sheet resistance, and excellent conductivity. Moreover, the present disclosure utilizes a transparent substrate laminated with an antenna pattern layer together to form a transparent thin-film antenna, rather than the existing technology that uses imprinting, printing, spraying, sputtering and other processes on the transparent substrate to form the transparent thin-film antenna, which simplifies the process. Furthermore, after laser depth-controlled cutting treatment, the bottom of the groove does not expose the base substrate, that is, does not cut through the conductive substrate, which can prevent the transparent substrate from curing together with the base substrate through the groove when laminated with the antenna pattern layer, thereby avoiding the inability to peel off the base substrate. The present disclosure can also utilize peelable base substrate and carrier copper layer to support the strength of the product during the manufacturing process, thereby reducing appearance defects caused by wrinkles, warping, etc.

### BRIEF DESCRIPTION OF THE DRAWINGS

FIG. 1 is a flow chart of the manufacturing process of a transparent thin-film antenna provided in the present disclosure;

FIG. 2 is a flow chart of the manufacturing process of another transparent thin-film antenna provided in the present disclosure;

FIG. 3 is a schematic diagram of a scenario for manufacturing a transparent thin-film antenna provided in an embodiment of the present disclosure.

The reference numbers in the figures:
1—base substrate;
2—conductive substrate;
2a—antenna pattern layer, 20—groove, 21—routing;
3—transparent substrate;
4—carrier copper layer;
5—transparent double-sided adhesive tape.

### DETAILED DESCRIPTION OF THE EMBODIMENTS

In order to solve the above-mentioned problems in the existing technology, the present disclosure provides a transparent thin-film antenna and its manufacturing method. These two protection themes are based on the same concept, and the principles for solving problems are basically the same or similar. The implementation methods of each protection theme can be referred to each other, and the redundant parts will not be reiterated.

The present disclosure provides a method for manufacturing a transparent thin-film antenna, including:
Providing a base substrate and a conductive substrate layered on the base substrate;
Performing laser depth-controlled cutting treatment on the conductive substrate to process the conductive substrate into an antenna pattern layer with a plurality of grooves, wherein the grooves limit a routing distance of the antenna pattern layer, and the portion between two adjacent grooves forms a routing of the antenna pattern layer;
Laminating a transparent substrate onto the antenna pattern layer to fill each groove with the transparent substrate;
Peeling off the base substrate to make the antenna pattern layer and the transparent substrate form a transparent thin-film antenna.

As mentioned above, the present disclosure uses laser depth-controlled cutting process to manufacture antenna pattern layers. Laser depth-controlled cutting has high accuracy and low cost, so there is no need to require additional molds, thereby eliminating reliance on high-precision imprint molds, reducing costs, and shortening lead time.

The type, specific structural design, length, thickness and other parameters of the transparent thin-film antenna can be determined according to the actual required adaptability. For example, the transparent thin-film antenna can be an ultra wide-band antenna, which can be applied to high-precision positioning devices, including but not limited to handheld devices such as mobile phones and wearable devices such as smart glasses.

In practical scenarios, the actual manifestation of the above steps should be determined according to the adaptability of the actual scenario. In order to clarify the purpose, technical solution, and advantages of the present disclosure, the technical solution of the present disclosure will be described clearly below in conjunction with specific embodiments and corresponding drawings. It is apparent that the embodiments described below are only a part of the embodiments of the present disclosure, not all of them. In the absence of conflicts, the following embodiments and their technical features can be combined with each other and also belong to the technical solution of the present disclosure.

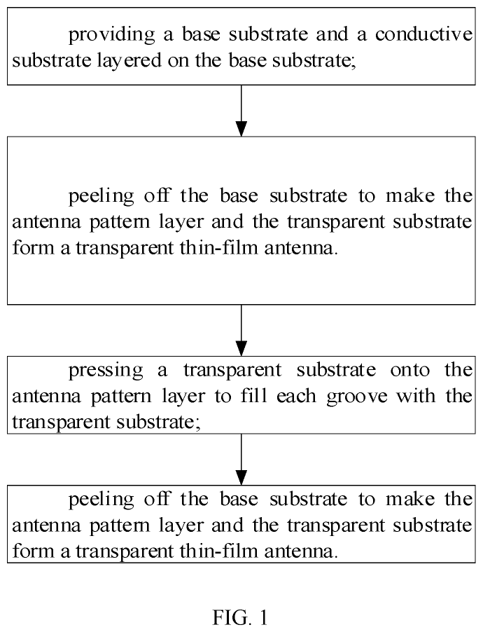

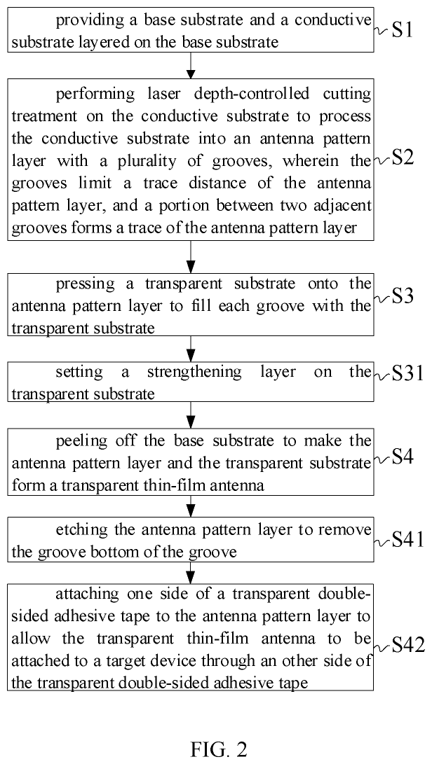

FIG. 1 is a flow chart of the manufacturing process of a transparent thin-film antenna provided in the present disclosure, and FIG. 2 is a flow chart of the manufacturing process of another transparent thin-film antenna based on FIG. 1. Referring to both FIG. 1 and FIG. 2, the method includes the following steps S1 to S4.
S1: Providing a base substrate and a conductive substrate layered on the base substrate.

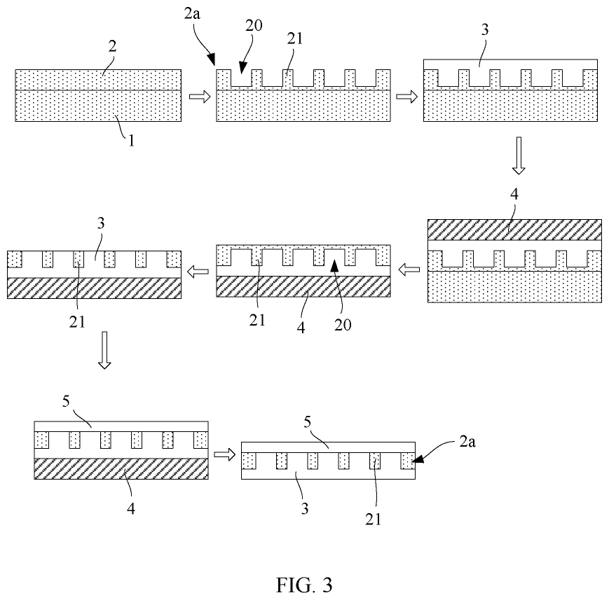

As shown in FIG. 3, when viewed along the direction perpendicular to the layer orientation, the orthographic projection of the conductive substrate 2 falls within the orthographic projection of the base substrate 1. The exemplary display in FIG. 3 shows that the two completely overlap vertically.

The base substrate 1 and the conductive substrate 2 can be uniformly made of copper foil, and their thicknesses can be different. The base substrate 1 has a thickness greater than that of the conductive substrate 2, for example, the conductive substrate 2 has a thickness of D1 and 0<D1≤6 μm, while the base substrate 1 has a thickness of D0 and D0≥9 μm.
S2: Performing laser depth-controlled cutting treatment on the conductive substrate to process the conductive substrate into an antenna pattern layer with a plurality of grooves, wherein the grooves limit a routing distance of the antenna pattern layer, and the portion between two adjacent grooves forms a routing of the antenna pattern layer.

Continuing to refer to FIG. 3, the so-called laser depth-controlled cutting treatment refers to the use of laser equipment to deeply cut the surface of the conductive substrate 2, forming grooves 20 with predetermined patterns on the conductive substrate 2. Each groove 20 is the blank area between adjacent two routings 21 in the antenna pattern layer 2a, which limits the routing distance of the antenna pattern layer 2a (namely the distance between adjacent routings 21). Correspondingly, the portion between two adjacent grooves 20, that is, the portion where the conductive substrate 2 is retained, forms the routing 21 of the antenna pattern layer 2a.

In one example, the depth of the groove 20 is smaller than the thickness of the conductive substrate 2, and the groove bottom of the groove 20 does not expose the base substrate 1, that is, the laser does not penetrate the conductive substrate 2.

The width of the groove 20 (i.e., the length along the horizontal direction x parallel to the conductive substrate 2) may be greater than or equal to 6 μm, and the portion between two adjacent grooves 20 (i.e., the width of a single routing 21) may be less than or equal to 6 μm. It should be understood that the width of each routing 21 can be the same or different, and the width of each groove 20 can be the same or different. For any single groove 20, the width of the groove 20 can always be the same along its extension direction. Similarly, for any single routing 21, the width of the routing 21 can always be the same along its extension direction. In addition, at least one of these parameters, i.e., the width of each routing 21, the width of groove 20, and the depth of groove 20, can be adaptively determined according to the actual scene requirements, and the embodiments of the present disclosure are not limited. For example, in the scenario where the thickness of the conductive substrate 2 satisfies 0<D1≤6 μm, the thickness of the groove bottom of the groove 20 can be greater than or equal to 0.1 μm.
S3: Laminating a transparent substrate onto the antenna pattern layer to fill each groove with the transparent substrate.

Please continue to refer to FIG. 3, the transparent substrate 3 can be a hybrid film, such as PET (Polyethylene terephthalate) film and transparent adhesive. Transparent adhesive is used to adhere PET film to the antenna pattern layer 2a. Optionally, transparent adhesive is filled in the grooves 20 and the junction between the routings 21 and the PET film, so that after the transparent adhesive is cured, the transparent substrate 3 and the antenna pattern layer 2a are cured together. The upper surface of the transparent substrate 3 is a horizontal plane.

In one example, the transmittance of the transparent substrate 3 can be greater than or equal to 85%, ensuring that the final produced transparent thin-film antenna has good transmittance. The thickness of the transparent substrate 3 can be adaptively determined. For example, in the example scenario shown in FIG. 3, the thickness of the transparent substrate 3 can be greater than or equal to 5 μm, and the thickness of the transparent adhesive can be greater than or equal to 5 μm.

Continuing to refer to FIG. 3, the method may further include step S31: setting a carrier copper layer 4 on the transparent substrate 3. The carrier copper layer 4 is set on the side of the transparent substrate 3 facing away from the antenna pattern layer 2a. The carrier copper layer 4 is configured to support the strength of the product during the manufacturing process, thereby reducing appearance defects caused by wrinkles, warping, etc.

In one example, the carrier copper layer 4 can be a PET film with a thickness greater than or equal to 25 μm.

The present disclosure can cover the upper surface of the transparent substrate 3 with the carrier copper layer 4 through a pressure-resistant synthesis process, and when viewed in a direction perpendicular to the transparent substrate 3, the front projection of the transparent substrate 3 can fall into the front projection of the carrier copper layer 4. The exemplary illustration in FIG. 3 shows that the two completely overlap vertically.

It should be understood that according to the thickness of the base substrate 1, the conductive substrate 2, and the transparent substrate 3, as well as the processing capacity of the production equipment and other practical scenarios, the carrier copper layer 4 may not be provided in the present disclosure.
S4: Peeling off the base substrate to make the antenna pattern layer and the transparent substrate form a transparent thin-film antenna.

Continuing to refer to FIG. 3, the product with the carrier copper layer 4 is flipped upside down, and the base substrate 1 is peeled off from the antenna pattern layer 2a. During the peeling process, the carrier copper layer 4 supports the strength of the product, thereby reducing the occurrence of wrinkles, warping, and other defects in the antenna pattern layer 2a and the transparent substrate 3.

Optionally, the peel strength of the base substrate 1 can be less than or equal to 0.3 kgf/cm.

Then, as shown in FIG. 2, the method further includes step S41: performing etching treatment on the antenna pattern layer 2a to remove the groove bottom of the groove 20, that is, thinning the thickness of the antenna pattern layer 2a through etching treatment, thereby exposing the part of the transparent substrate 3 that was originally blocked by the groove bottom of the groove 20, ensuring that the various routings 21 in the antenna pattern layer 2a are not connected. At this point, the remaining antenna pattern layer 2a and the transparent substrate 3 form a transparent thin-film antenna. In one example, etching treatment can be performed using fast etching or micro-etching processes.

Continuing to refer to FIG. 3 and in conjunction with FIG. 2, the method may further include step S42: attaching one side of the transparent double-sided adhesive tape 5 to the antenna pattern layer 2a to allow the transparent film antenna to be adhered to the target device through the other side of the transparent double-sided adhesive tape 5.

After attachment, the routings of the antenna pattern layer 2a are in direct contact with the transparent double-sided adhesive tape 5.

The transparent double-sided adhesive tape 5 includes but is not limited to at least one of OCA (Optical Clear Adhesive) and PET double-sided adhesive tape. OCA generally has a light transmittance of over 90% and has minimal shrinkage when cured at room or medium temperatures. The orthographic projection of the antenna pattern layer 2a and the transparent substrate 3 can fall into the orthographic projection of the transparent double-sided adhesive tape 5, as shown in FIG. 3, where they overlap completely vertically.

After attaching one side of the transparent double-sided adhesive tape 5 to the antenna pattern layer 2a, as shown in FIG. 2, the method may further include step S43: peeling off the carrier copper layer 4. At this point, the final formed transparent thin-film antenna includes the antenna pattern layer 2a, the transparent substrate 3, and the transparent double-sided adhesive tape 5. Of course, the transparent double-sided adhesive tape 5 can also be peeled off when or after attaching the transparent thin-film antenna to the target device.

As mentioned above, the present disclosure uses laser depth-controlled cutting process to manufacture antenna pattern layers 2a. Laser depth-controlled cutting has high accuracy and low cost, so there is no need to require additional molds, thereby eliminating reliance on high-precision imprint molds, reducing costs, and shortening lead time. The transmittance of the transparent thin-film antenna produced in the present disclosure ranges from 70% to 100%, which has the advantages of meeting the current industry demand and exceeding the current technological level.

In addition, the present disclosure can use copper foil in conjunction with laser depth-controlled cutting process to manufacture antenna pattern layers 2a, compared to existing conductive materials composed of nano silver and polymer resins, the present disclosure uses copper foil with lower cost to manufacture conductive materials (such as the aforementioned conductive substrate 2 and routing 21), thus, material costs can be significantly reduced. Moreover, due to the use of copper foil without the need for polymer resin, the influence of polymer resin on sheet resistance and conductivity can be eliminated, resulting in a product produced in the present disclosure with low sheet resistance and excellent conductivity.

Further, the present disclosure utilizes a transparent substrate 3 laminated with an antenna pattern layer 2a together to form a transparent thin-film antenna, rather than the existing technology that uses imprinting, printing, spraying, sputtering and other processes on the transparent substrate to form the transparent thin-film antenna, which simplifies the process. Furthermore, after laser depth-controlled cutting treatment, the groove bottom of the groove 20 does not expose the base substrate 1, that is, does not cut through the conductive substrate 2, which can prevent the transparent substrate 3 from curing together with the base substrate 1 through the groove 20 when laminated with the antenna pattern layer 2a, thereby avoiding the inability to peel off the base substrate 1.

The present disclosure can also utilize peelable base substrate 1 and carrier copper layer 4 to support the strength of the product during the manufacturing process, thereby reducing appearance defects caused by wrinkles, warping, etc.

It should be understood that the manufacturing method of transparent thin-film antenna is a complete manufacturing process, which also includes other steps involved in the manufacturing process, and can refer to the existing technology, which will not be described in details for brevity in the embodiments of the present disclosure.

The transparent thin-film antenna provided in the present embodiment is made using any of the aforementioned methods. Consequently, this transparent thin-film antenna possesses the beneficial effects derived from the corresponding method described in the examples, which are not reiterated here.

The transparent thin-film antenna may have a structure as shown in the last figure of FIG. 3, that is, the transparent thin-film antenna includes an antenna pattern layer 2a, a transparent substrate 3, and a transparent double-sided adhesive tape 5. In other examples, the transparent thin-film antenna may include an antenna pattern layer 2a and a transparent substrate 3, without the need for transparent double-sided adhesive tape 5. In practical scenarios, the transparent thin-film antenna can be attached to the target device using glue or other methods.

It should be understood that the transparent thin-film antenna provided in the embodiments of the present disclosure is a complete device and also has the corresponding structure of known transparent thin-film antennas, such as radiation patches connected to the routing 21 for transmitting and receiving electromagnetic wave signals, various types of feed points for realizing the power connection of the routing 21, and ground points, which will not be elaborated here.

The above description is only a partial embodiment of the present disclosure and does not limit the patent scope of the present disclosure. For those skilled in the art, any equivalent structural transformation made using the content of this specification and drawings is also included in the scope of the present disclosure.

It should be understood that step codes such as S1, S2, etc. are intended to express the corresponding content more clearly and concisely, and do not constitute substantive limitations in order. Those skilled in the art may, for example, execute S3 first and then execute S2 during specific implementation, which should be within the scope of the present disclosure.

Although this article uses terms such as “first” and “second” to describe various information, these terms should not be limited to them. These terms are only used to distinguish information of the same type from each other. In addition, the singular forms of “one”, “a”, and “this” are intended to also include the plural form. The terms “or” and/or “are” interpreted as inclusive or imply any one or any combination. Exceptions to this definition only occur when a combination of components, functions, steps, or operations are inherently mutually exclusive in certain ways.

In the description of the embodiments of the present disclosure, the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counterclockwise” and other directional or positional relationships indicated are based on the directional or positional relationships shown in the accompanying drawings, only for the convenience of describing the technical solutions of the corresponding embodiments, and do not indicate or imply that the device or component must have a specific orientation, or be constructed and operated in a specific orientation, and it cannot be understood as a limitation of the present disclosure.

What is claimed is:

1. A method for manufacturing a transparent thin-film antenna, comprising:
providing a base substrate and a conductive substrate layered on the base substrate;
performing laser depth-controlled cutting treatment on the conductive substrate to process the conductive substrate into an antenna pattern layer with a plurality of grooves, wherein the grooves limit a routing distance of the antenna pattern layer, and a portion between two adjacent grooves forms a routing of the antenna pattern layer; a depth of the groove is less than a thickness of the conductive substrate, and a groove bottom of the groove does not expose the base substrate;
laminating a transparent substrate onto the antenna pattern layer to fill each groove with the transparent substrate, wherein the transparent substrate comprises PET film and transparent adhesive, and the transparent adhesive is filled in the groove and the junction between the routing and the PET film to adhere the PET film to the antenna pattern layer;
setting a carrier copper layer on the transparent substrate, then peeling off the base substrate to expose a side of the antenna pattern layer set with the groove bottom of the groove;
etching the antenna pattern layer to remove the groove bottom of the groove, so as to make the antenna pattern layer and the transparent substrate form a transparent thin-film antenna.

2. The method according to claim 1, wherein the conductive substrate is copper foil.

3. The method according to claim 2, wherein the thickness of the conductive substrate is D₁, and 0<D₁≤6 μm, and the thickness of the groove bottom of the groove is greater than or equal to 0.1 μm.

4. The method according to claim 1, wherein the method further comprises:
attaching one side of a transparent double-sided adhesive tape to the antenna pattern layer to allow the transparent thin-film antenna to be attached to a target device through another side of the transparent double-sided adhesive tape.

5. The method according to claim 4, wherein after attaching one side of the transparent double-sided adhesive tape to the antenna pattern layer, the method further comprises:
peeling off the carrier copper layer.

6. The method according to claim 1, wherein a transmittance of the transparent substrate is greater than or equal to 85%.

7. The method according to claim 1, wherein the transparent substrate is a PET film.

8. A transparent thin-film antenna, wherein the transparent thin-film antenna is made using the method according to claim 1.
